(19) United States
(12) Patent Application Publication
(10) Pub. No.: US 2012/0197625 A1
(43) Pub. Date: Aug. 2, 2012

(54) Data-dependency-Oriented Modeling Approach for Efficient Simulation of OS Preemptive Scheduling

(75) Inventors: Peng-Chih WANG, Xiluo Township (TW); Meng-Huan Wu, Hsinchu City (TW); Ren-Song Tsay, Jhubei City (TW)

(73) Assignee: National Tsing Hua University, Hsin Chu City (TW)

(21) Appl. No.: 13/016,933

(22) Filed: Jan. 28, 2011

(51) Int. Cl. G06F 9/45

(52) U.S. Cl. 703/22

(57) ABSTRACT

In the present disclosure, the DOM approach for the simulation of OS preemptive scheduling has presented and demonstrated. By maintaining the data-dependency between the software tasks, and guaranteeing the order of shared variable accesses, it can accurately simulate the preemption effect. Moreover, the proposed DOM OS model is implemented to enable preemptive scheduling in SystemC.

### TECHNICAL FIELD

The present invention is generally related to a method for operating system (OS) modeling simulation. More particularly, the present invention is directed to a data-dependency-oriented modeling approach for efficient simulation of OS preemptive scheduling.

### DESCRIPTION OF THE RELATED ART

With the development of technology, instruction-set simulator (ISS) is an indispensable tool for system level design. A hardware designer is able to perform the exploration and/or verification by an instruction-set simulator before the realization of the design. As a result, it is able to decrease the non-recurring engineering cost (NRE cost) in product development. A software designer can test a program on an instruction-set simulator instead of running it on real target machines, and hence the turnaround time can be reduced.

After several years of development, the performance of the traditional instruction-set simulator integrated into a single core machine is nearly optimum (fast and accurate). However, as the evolution of semiconductor manufacturing processes, two or more processors can be encapsulated in a single chip. Traditional single-core systems have been gradually substituted by multi-core systems. In order to maximize multi-core efficiency, more and more applications or programs are developed by using parallel programming model; however, the instruction-set simulator of a traditional single core system cannot manage the different cores synchronously so that simulations by different cores are not executed efficiently.

Conventionally, instruction-set simulators (ISS) are widely adopted to run specific OSs for software simulation, but the achievable simulation speed is only few million instructions per second (MIPS). For efficient system-level simulation, the concept of Operating system (OS) modeling has been proposed recently. The idea is to abstract routine OS operations into an efficient model and simulate only the application part at the fine-gained level.

OS models are widely used to alleviate the overwhelmed complexity of running system-level simulation of software applications on specific OS implementation. However, current OS modeling approaches are unable to maintain both simulation speed and accuracy when dealing with preemptive scheduling. In a modern OS system, the preemptive scheduler dynamically alters the interleaving between software tasks. Different interleaving sequences may introduce different execution results. Hence, it is critical to simulate the effect of preemptive scheduling correctly when validating software.

To model detailed preemption behavior correctly, mostly the cycle-accurate (CA) modeling approach is adopted. At each cycle, the CA approach swaps between simulated tasks and the OS model. Nevertheless in reality, the overheads caused by frequent swaps severely degrade the simulation performance.

In contrast, coarse-grained approaches swap at the boundaries of software program basic blocks or functions. Although these coarse-grained approaches greatly reduce swapping overheads, the preemption behavior cannot be simulated at the correct time point. As a result, the delayed handling of preemption can lead to an inaccurate interleaving sequence, and the simulation results may be false-negative, in which error is not detected as a result of incorrect simulation.

With the development of technology, instruction-set simulator (ISS) technique has been widely used for software simulation. Although it can accurately simulate the preemptive scheduling of target OS, its poor performance (only a few MIPS) is not practical for full system simulation.

Although some dynamic compiled ISS techniques allow high software simulation performance (approximately a hundred MIPS), such as QEMU (F. Bellard, “QEMU, a fast and portable dynamic translator”, In ATEC: Proceedings of the annual conference on USENIX Annual Technical Conference, pp. 41-41, 2005), which uses a binary translation approach, their implementation is complex and difficult to integrate into HW/SW co-simulation frameworks such as SystemC.

To improve the performance of integration in a co-simulation framework, abstract OS modeling approaches are proposed. However, current high-speed OS modeling approaches cannot accurately simulate the effect of preemptive scheduling and may produce inaccurate software execution result.

As discussed above, the CA modeling approach would have massive swapping overheads and hence poor simulation performance. To deal with this issue, this paper proposes a data-dependency-oriented modeling (DOM) approach.

### SUMMARY

To resolve above-mentioned issue, the present invention proposes a data-dependency-oriented modeling approach for efficient simulation of OS preemptive scheduling. By guaranteeing the order of shared variable accesses, accurate simulation results are obtained.

One advantage of the present invention allows that the simulation not only offers the same simulation results as CA modeling but also largely reduces swapping overheads, and thereby reaching the purpose of a fast and accurate simulation of the preemption effect.

The other advantage of the present invention is that the simulation effort of the present's approach is considerably less than that of the conventional Cycle-Accurate (CA) modeling approach, thereby leading to high simulation speed, 42 to 223 million instructions per second (MIPS) or 114 times faster, than CA modeling.

The data-dependency-oriented modeling method for efficient simulation of OS preemptive scheduling disclosed by the present invention comprises checking a data access address on a DOM OS model for each simulated software tasks. Then, a time to a next shared variable access by calling a wait function is computed by the DOM OS model, followed by executing operation of the simulated software task and submitting a control back to a SystemC engine for simulating each hardware tasks. Subsequently, SystemC engine by calling wait function is requested by DOM OS model to mimic a time delay for a preempted software task and trigger the preempted software task to execute when encountering a preemption event.

The method further comprises a step of sending an interrupt to notify a processor when the hardware task needs to interact with a specific simulated software task. The processor suspends a current simulated software task to invoke a corresponding interrupt service routine. The method further comprises a step of performing context switch by an OS scheduler to execute the specific simulated software task, otherwise executing the suspended simulated software task.

The method further comprises a step of scheduling the simulated software tasks and the hardware tasks based-on the calling wait function by SystemC engine. DOM OS model records an interrupt event in an Interrupt Event Queue when the interrupt event is issued by the hardware task.

The method further comprises a step of checking an Interrupt Event Queue by DOM OS model when DOM OS model is invoked. The method further comprises a step of the preempted software task waiting a suspension time which is a computing time of the preempted software task execution, otherwise, an executing software task resuming execution at the next shared variable access after checking Interrupt Event Queue, wherein checking of preempted software task will be recursively executed until there is no interrupt in the Interrupt Event Queue.

The checking a data access address comprises checking whether the data access address is of a shared data access; if it is, DOM OS model will compute a time from last shared variable access and annotate the computing time to wait function to invoke SystemC engine for simulation, if it is not, back to the simulated software task.

To further understand technical contents, methods and efficacy of the present invention, please refer to the following detailed description and drawings related the present invention.

### BRIEF DESCRIPTION OF THE DRAWINGS

The invention is more fully appreciated in connection with the following detailed description taken in conjunction with the accompanying drawings; however, those skilled in the art will appreciate that these examples are not intended to limit the scope of the present invention, and various changes and modifications are possible within the spriit and scope of the present invention.

FIG. 1a illustrates an interleaving sequence which results in program segmentation fault.

FIG. 1b illustrates an interleaving and access order of shared variables following a function-level modeling of OS preemptive scheduling.

FIG. 1c illustrates an interleaving and access order of shared variables following the cycle-accurate modeling of OS preemptive scheduling.

FIG. 1d illustrates an interleaving and access order of shared variables following the proposed data-dependency oriented modeling of the present invention.

FIG. 2 illustrates a simulation flow incorporating DOM OS model in SystemC according to the present invention.

FIG. 3a illustrates a concurrent simulation result from the aspect of simulated clock.

FIG. 3b illustrates the true time-sharing behavior of the target system.

FIG. 3c illustrates the time-sharing behavior from the concurrent simulation by adopting timing adjustment mechanism of DOM OS model.

FIG. 4 illustrates a timing adjustment flow of software tasks in DOM OS model.

FIG. 5 is identifying shared variable access during run-time in a DOM OS model.

FIG. 6 illustrates the simulation accuracy of the WatchDog Timer with different OS modeling approaches.

### DETAILED DESCRIPTION

In the description below, for the purposes of explanation, numerous specific details are set forth in order to provide a thorough understanding of the present invention. It will be apparent, however, to one skilled in the art that the present invention may be practiced without some of these specific details. Furthermore, the terms described in the preferred embodiment of the present invention shall be interpreted in most extensive and reasonable way.

In the present invention, the DOM approach for the simulation of OS preemptive scheduling has presented and demonstrated. By maintaining the data-dependency between the software tasks, it can accurately simulate the preemption effect. Moreover, the proposed DOM OS model is implemented to enable preemptive scheduling in SystemC. The experimental results show that the preemptive scheduling simulation using the present invention's modeling approach can perform 114 times faster than the CA OS model while maintaining the same accuracy.

In the present invention, the proposed DOM of the present invention not only offers the same simulation results as CA modeling but also largely reduces swapping overheads. Hence, it is capable of a fast and accurate simulation of the preemption effect.

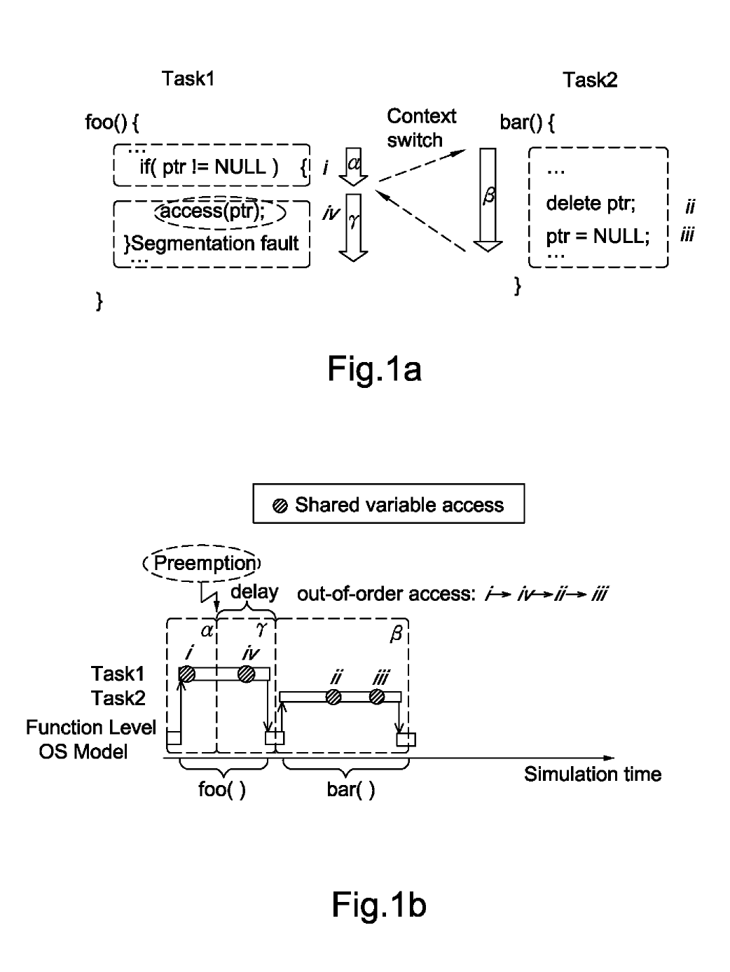

FIG. 1a illustrates an interleaving sequence which results in program segmentation fault. In FIG. 1a, a particular interleaving sequence, a→β→γ, leads to a program segmentation fault. Ideally, after checking the null pointer, Task1 is supposed to successfully access the non-null pointer, but the OS scheduler unintentionally preempts Task1 right after the checking and switches to Task2. Task2 assigns the pointer as null. Subsequently, Task2 deletes the given pointer, so that when Task1 resumes its execution, the invalid pointer access will crash the program, i.e. creating a program segmentation fault. Thus, such software design leads to a latent bug due to preemption effect. Undoubtedly, designers would like to reveal this type of error while validating software applications with an OS model.

To achieve high-speed simulation, the swapping overheads must be reduced. An overhead reduction approach is to limit task swapping at the boundaries of functions or basic blocks of simulated software tasks. However, since preemption may occur at any time point, the effect of preemption cannot be captured accurately with proper ordering mechanisms.

FIG. 1b illustrates an interleaving and access order of shared variables following a function-level modeling of OS preemptive scheduling. Based on the function-level OS model, it swaps executions at function boundaries. FIG. 1b shows the simulation result of the case in FIG. 1a. The preemption handling is deferred until the end of the function foo( ) thereby leading to different task interleaving, αγ→β. As a basic block of simulated software tasks or the function foo( ) is executed, followed by scheduling to greatly reduce swapping overhead. In this case, the program execution no longer crashes due to this incorrect simulation sequence, and this bug will be missed, making it a false negative result. Similarly, a basic-block-level OS model (please refer to: S. Yoo, G. Nicolescu, L. Gauthier, A. Jerraya, “Automatic generation of Fast Timed Simulation Models for Operating Systems in SoC Design”, In DATE: Proceedings of the conference on Design, automation and test in Europe, pp. 620627, 2002) may incur the same issue.

FIG. 1c illustrates an interleaving and access order of shared variables following the cycle-accurate modeling of OS preemptive scheduling. Instead, a cycle-accurate modeling approach (please refer to: I. Bacivarov, S. Yoo, and A. Jerraya, “Timed HW-SW Cosimulation Using Native Execution of OS and Application SW”, In HLDVT: Proceedings of the Workshop on High Level Design Validation and Test, pp. 51-56, 2002) that swaps between simulated tasks and the OS model at each cycle, as shown in FIG. 1c, can accurately produce correct results due to the same interleaving sequence, α→β→γ, as FIG. 1a. Based-on cycle-accurate modeling approach, control is back to SystemC after each cycle, and simulated software task is selected by OS model and then executed by SystemC.

As discussed above, the efficient function-level OS model leads to inaccurate simulation result and the accurate cycle-accurate OS model results in massive simulation overhead. In order to be both efficient and accurate in simulating the preemption behaviors, a data-dependency-oriented (DOM) approach is introduced. By guaranteeing the order of shared variable accesses, accurate simulation results are obtained. Meanwhile, the simulation effort of the present's approach is considerably less than that of the conventional Cycle-Accurate (CA) modeling approach, thereby leading to high simulation speed, 42 to 223 million instructions per second (MIPS) or 114 times faster, than CA modeling as supported by the present's experimental results.

Based on observations of data-dependency, although task interleaving sequences can differ due to varying preemption event points, execution results are actually determined by their shared variable access order, i.e., data-dependency. In fact, as long as the interleaving sequences have the same data-dependency, their execution results are identical.

Previous works conclude that consistent data-dependency can be guaranteed if the execution order of shared variable accesses is maintained. It shows that software applications on multi-core system can be simulated accurately and efficiently by effectively maintaining the data-dependency. Based on the data-dependency concept, it further provides an efficient and accurate coarse-grained-level software application simulation approach.

In order to maintain the same data-dependency of the original execution, the proposed DOM of the present invention swaps between the OS model and simulated tasks at each shared variable access point. The swapping of executions maintains data integrity influenced by the task interleaving sequence. In fact, only shared variable accesses can affect data integrity. For better understanding, the example in FIG. 1 is used to demonstrate how the DOM approach works.

As shown in FIG. 1b, when applying function-level modeling, the delay of preemption handling incurs the accesses to the shared variables, ptr, i.e., i→iv→ii→iii. However, the cycle-by-cycle execution diagram of the two interleaving tasks is shown in FIG. 1c, in which the accesses to the shared variables, ptr, are marked as i, ii, iii, and iv according to their access ordering. Hence, the data-dependency ordering is violated in function-level modeling since the out-of-order access to ptr.

FIG. 1d illustrates an interleaving and access order of shared variables following the proposed data-dependency oriented modeling of the present invention. In contrast as illustrated in FIG. 1d, DOM can maintain the same (consistent) access ordering, i.e., i→ii→iii→iv as the CA execution by synchronizing (or swapping) at the shared variable access points. Although the delayed preemption handling in DOM still alters the interleaving between Task1 and Task2 from α→β→γ to αγ′→β→γ″, the out-of-order portions β and γ′ have no shared variable access. Therefore, their execution order does not affect the execution result, and an accurate simulation is obtained.

In the following, it gives details on how to employ the proposed DOM OS model for preemptive scheduling in SystemC. SystemC is an IEEE standard as a collaborative platform for software and hardware and has been widely applied to early-stage system simulation. The proposed DOM OS model of the present invention can be incorporated into SystemC. The SystemC engine adopts a concurrent simulation strategy: the executable HW/SW (hardware/software) tasks on SystemC are executed concurrently. Nevertheless, in the target single-core system, the software tasks are in fact sequentially executed.

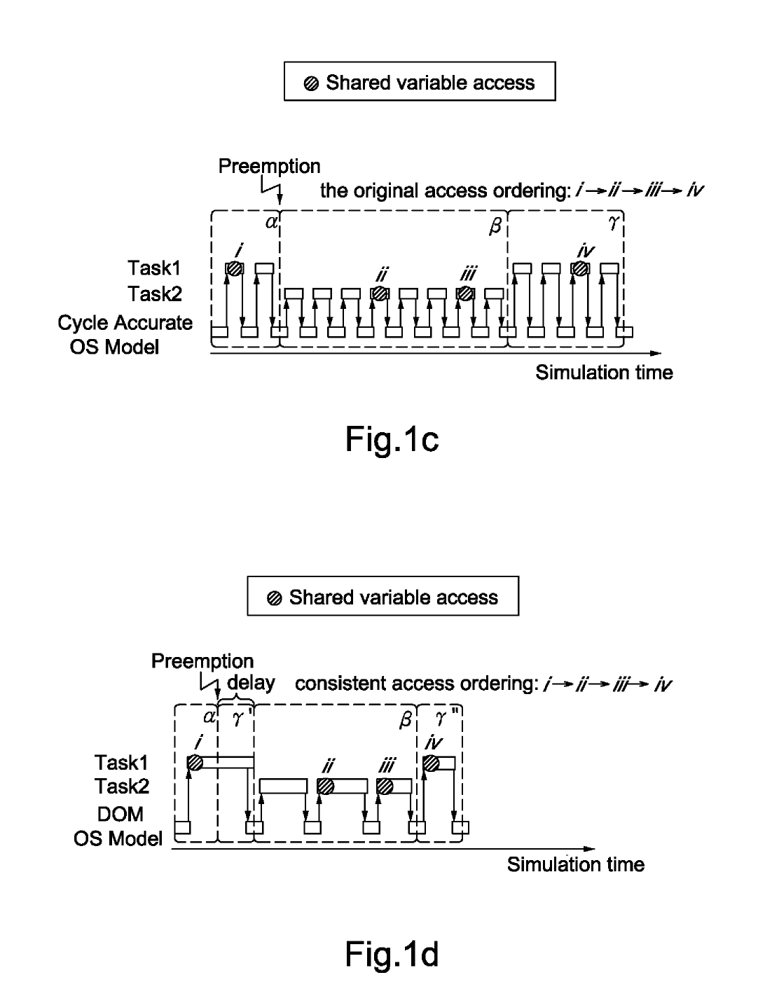

FIG. 2 shows a simulation flow incorporating DOM OS model in SystemC. It depicts the HW/SW co-simulation diagram. In this simulation flow, the proposed DOM OS model 102 manages the execution order of executable software tasks 104 while the SystemC engine 100 still manages the scheduling of hardware tasks 101. In addition, the SystemC engine 100 provides a cooperative scheduling execution of the hardware tasks 101.

When a software task 104 is executable, the SystemC engine 100 invokes the DOM OS model 102. Afterwards, DOM OS model 102 will first compute the time to next shared variable access by calling a wait( ) function, which will execute operations of the simulated software task and submit control back to SystemC for each hardware task 101 simulation. The SystemC engine 100 schedules HW/SW task 101/104 based-on the calling wait( ) function (computing or suspension time), meanwhile HW task 101 may be invoked for execution.

In reality, the executing software can be preempted due to interrupts. For example, when a hardware task 101 needs to interact with a specific software task 104, it will send an interrupt to notify a processor. The processor will suspend the current software task 104 to invoke a corresponding interrupt service routine (ISR). Afterwards, if necessary, an OS scheduler performs context switch to execute the specific software task 104. Otherwise, it just resumes the suspended software task 104.

In SystemC, an interrupt is modeled as a SystemC event. When an interrupt event is issued by a hardware task 101, DOM OS model 102 will record it in an Interrupt Event Queue 103. Afterwards, the DOM OS model 102 will check the Interrupt Event Queue 103 and consider the preemption effect (event) when it is invoked.

When encountering a preemption event, the DOM OS model 102 will request the SystemC engine 100 by calling wait function to mimic the time delay for a preempted software task 104 and trigger the preempted software task to execute. Otherwise, it will just resume execution of the current software task.

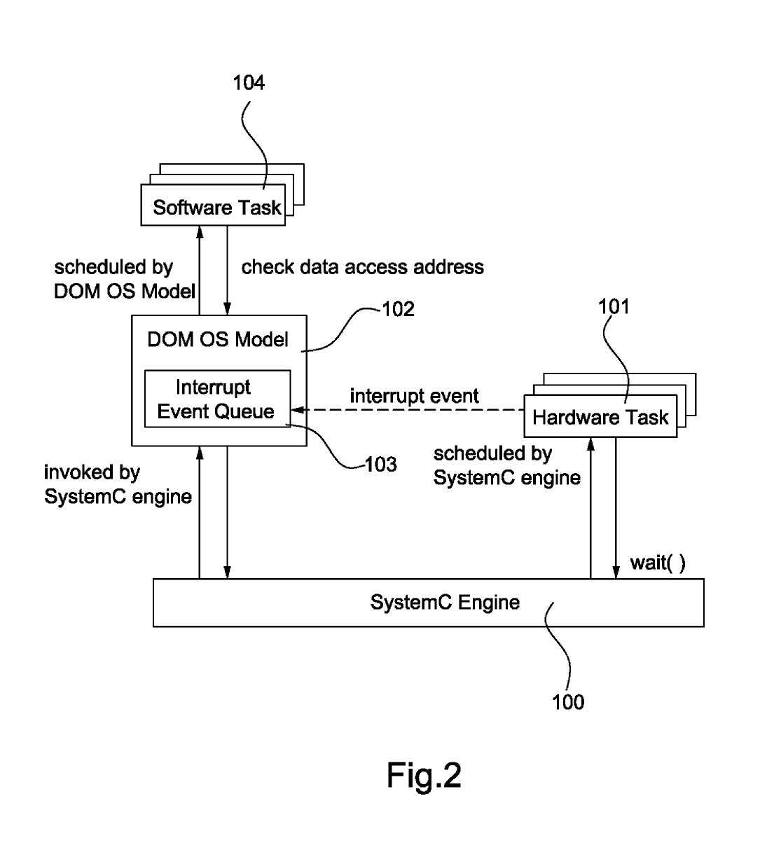

Because the SystemC engine is mainly designed to simulate the concurrent behavior of hardware tasks, the timing behavior of different tasks can appear to overlap in the perspective of simulated time. To illustrate the behavior, FIG. 3 demonstrates the simulation results following the example in FIG. 1a. Here, software Task1 starts first and then software Task2 is launched at t₂. Following the concurrent behavior, the SystemC engine simulates their overlapped executions shown in FIG. 3a. FIG. 3a illustrates a concurrent simulation result from the aspect of simulated clock. The simulated times of Task1 and Task2 are overlapped due to the concurrent simulation scheduling of SystemC.

However, in a time-sharing multi-tasking OS system, software tasks are cooperatively performed one at a time. The execution of the two software tasks in the target system should be as depicted in FIG. 3b. FIG. 3b depicts the true time-sharing behavior of the target system. Therefore, when using SystemC to simulate the timing behavior of software tasks, the tasks will be confused by the overlapped simulated time.

To resolve the issue, the OS model of the present invention first ensures correct time-sharing behavior and then adopts the timing adjustment mechanism by adjusting the simulated task end time to be the same as that in the target system.

To simulate the time-sharing behavior, the DOM OS model lets the preempted software tasks wait further the suspension time as shown in FIG. 3c. It is noted that this FIG. 3c is depicted from the aspect of simulated clock which indicates the simulated time of the target. In other words, it shows the time-sharing behavior from the concurrent simulation by adopting timing adjustment mechanism of DOM OS model. In contrast, simulation time implies the time to simulate on the host. Although the simulated times still overlap, the preempted task is suspended execution to mimic time-sharing behavior.

In order to mimic the time delay (or suspension time) of the preempted task, the DOM OS model 102 has to perform a timing adjustment for time-sharing effect.

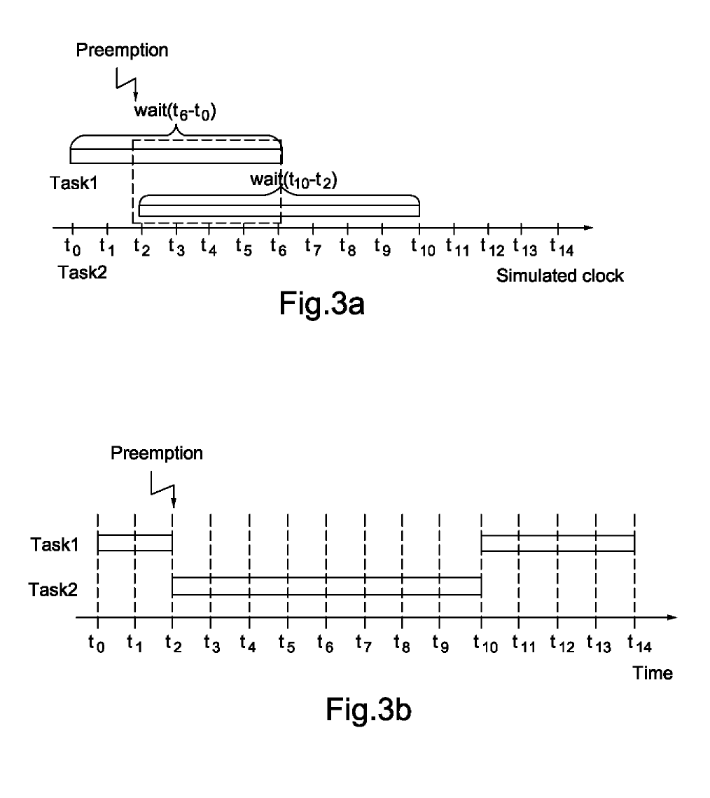

FIG. 4 shows a timing adjustment flow of software tasks in DOM OS model, which indicates how the mechanism works by checking the Interrupt Event Queue. Timing adjustment mechanism is implemented by the following steps. In the step 110, the DOM OS model is invoked by the SystemC engine. In the step 111, it is followed by checking the Interrupt Event Queue. In the step 113, if an interrupt event is issued by a hardware task, a suspension time is equal to the computing time of preempting task, and then the preempted software task will wait the suspension time, in the step 114. In other words, if there is a preemption event, the preempted software task will wait the suspension time which is the computing time of preempting software task execution. Otherwise, the executing software task will resume execution at the next shared variable access, in the step 112. The checking of preemption will be recursively executed until there is no interrupt in Interrupt Event Queue.

The purpose of having suspension time is to mimic the time-sharing behavior by forcing the preempted software task to suspend program execution. During suspension time, the preempted task does nothing and consumes only time, depicted as the shaded segment in FIG. 3c. Although tasks still overlap with the execution from t₂ to t₄ due to the SystemC engine, the end time of simulated clock will be the same as time-sharing with the timing adjustment.

This followings discusses how shared variables are identified by shared allocation routine in the present invention's implementation. The purpose of the identification is to mimic the data allocation mechanism of the OS. In addition to the preemptive scheduling, our OS model also provides the required shared allocation routine for software task implementation. A software task can use the routine to allocate shared data once the allocation function is called. Afterwards, the address of the shared data is then recorded for simulation use.

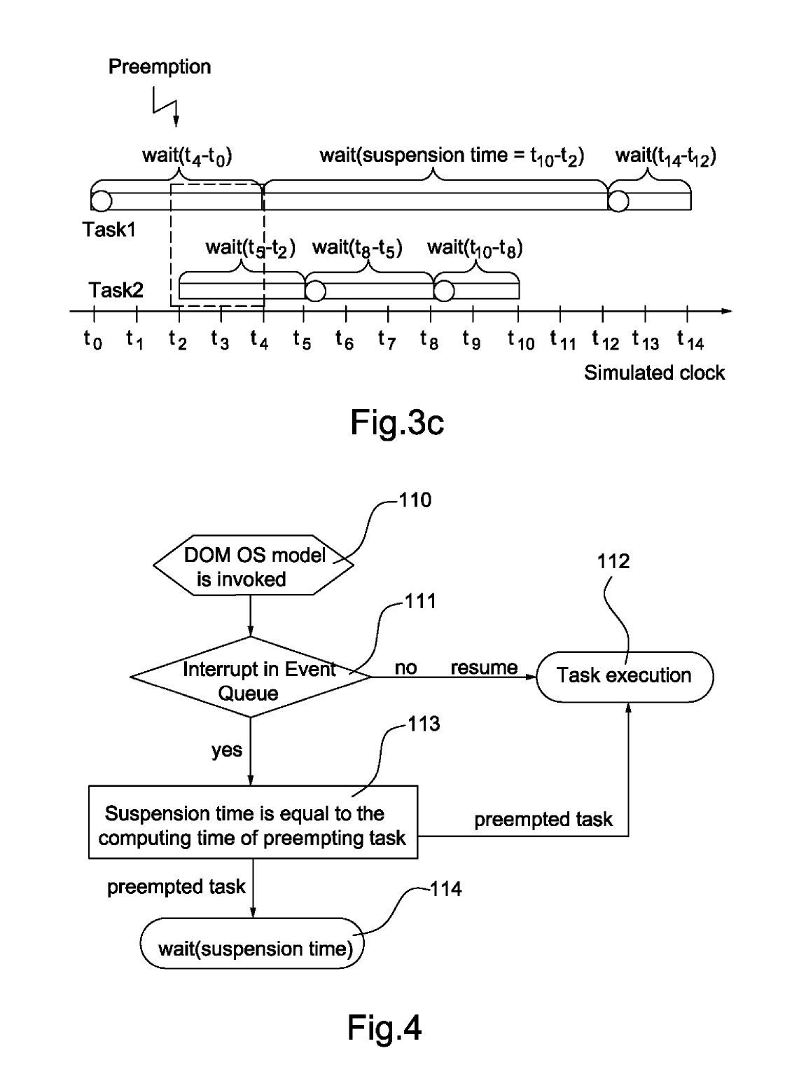

FIG. 5 is identifying shared variable access during run-time in a DOM OS model. As shown in FIG. 5, when a simulated software task issues a memory access, it will check whether a target (data access) address 121 is of shared data (access) 122. It may refer to the shared data address table 120. If it is, the DOM OS model 102 will compute the time from last shared variable access and annotate the computing time to the wait( ) function in the step 123 to invoke the SystemC engine for simulation. If it is not, back to the simulated software task.

In this way, the DOM OS model 102 can guarantee the data-dependency by maintaining the temporal order of shared variable accesses.

To verify the proposed DOM OS model, it performed an experiment to demonstrate the simulation speed and another one to confirm the simulation accuracy. The proposed DOM OS model is implemented and integrated into the SystemC kernel.

During simulation, the DOM OS model is invoked to process preemption events at shared variable access points. It followed the timing annotation ideas and dynamically annotated the computing time of each task.

As illustrated below, Table 1 summarizes the simulation speed benchmark results for a few OS modeling approaches using SPLASH-2 parallel programs (please refer to: S. Woo, M. Ohara, E. Torrie, J. Singh, A. Gupta, “The SPLASH-2 Programs: Characterization and Methodological Considerations”, In ISCA: Proceedings of the international symposium on Computer architecture, pp. 24-36, 1995). The barnes, lu, ocean, fft, fmm and radix benchmarks are implemented into 2, 4 and 8 tasks. Each task is executed in turn when the target processor is periodically notified by a timer interrupt.

TABLE 1

| | | CA | BB | DOM |
|---|---|---|---|---|
| Bench | Shared Variable | Sim. Speed | Sim. Speed | Sim. Speed |
| Programs | Access Rate | (MIPS) | (MIPS) | (MIPS) |
| barnes_2 | 7.46% | 2.1 | 16.8 | 53.0 |
| barnes_4 | 7.77% | 2.0 | 15.9 | 48.9 |
| barnes_8 | 8.36% | 1.9 | 15.4 | 42.1 |
| lu_2 | 3.14% | 2.2 | 18.3 | 73.5 |
| lu_4 | 3.16% | 2.0 | 17.6 | 71.5 |
| lu_8 | 3.26% | 1.9 | 16.2 | 66.6 |
| ocean_2 | 1.81% | 2.1 | 18.4 | 97.5 |
| ocean_4 | 1.82% | 2.0 | 17.1 | 95.8 |
| ocean_8 | 3.36% | 1.8 | 15.8 | 60.2 |
| fft_2 | 0.93% | 2.1 | 18.2 | 140.3 |
| fft_4 | 1.16% | 2.0 | 17.6 | 130.2 |
| fft_8 | 1.12% | 1.9 | 16.4 | 128.2 |
| fmm_2 | 0.71% | 2.1 | 18.4 | 170.4 |
| fmm_4 | 0.47% | 2.0 | 17.1 | 179.4 |
| fmm_8 | 0.36% | 1.9 | 16.4 | 182.4 |
| radix_2 | 0.08% | 2.2 | 18.6 | 223.1 |
| radix_4 | 0.10% | 2.1 | 17.5 | 217.1 |
| radix_8 | 0.09% | 1.9 | 16.7 | 221.9 |

Among all cases, the simulation speed of CA OS model is consistently at around 2 MIPS. As for the basic-block level (BB) OS model, in average each basic block contains 3 to 6 instructions and hence the simulation speed is improved to be around 18 MIPS.

In contrast, the DOM OS model swaps between the OS model and executing tasks only at each shared variable access, and hence the simulation speed is further raised up to the range of 42 to 223 MIPS.

The variation of the simulation speed actually depends on the density of shared variable access. Simulation speed is lower for cases of higher shared variable access rate. Particularly, the radix example has only few shared variable accesses, so its simulation on the DOM OS model is faster than other benchmarks.

Furthermore, to show that the shared variable access rate greatly influences the simulation performance, the producer-consumer program of ADPCM encoder and decoder from MiBench (please refer to: M. Guthaus, J. Ringenberg, D. Ernst, T. Austin, T. Mudge, R. B. Brown, “MiBench: A free, commercially representative embedded benchmark suite”, In WWC-4: Proceedings of the Workshop on Workload Characterization, pp. 3-14, 2001) is adopted. The ADPCM is a signal encoding program. In the design, there is a FIFO shared by both the encoder and decoder tasks. The encoder produces data into the FIFO and then the decoder consumes the FIFO data. Upon a half-filled FIFO, a controller sends an interrupt to trigger the encoder task to work. The application has a very high shared variable access rate, but the simulation speed based on the DOM OS model can still achieve 40.1 MIPS, compared to 9.6 MIPS on the BB model and 1.7 MIPS on the CA OS model.

Besides, the present invention's second experiment verifies the simulation accuracy. In this experiment, the WatchDog Timer benchmark is adopted and followed by comparing the final simulation results from the BB OS model and the DOM OS model with that of the CA OS model.

The WatchDog Timer is a widely adopted benchmark for a multi-tasking OS system to demonstrate its deadlock solution involving two or more tasks. When a deadlock occurs, the multi-tasking OS system is busy waiting and the processor is stalled, and no task can continue execution. The principle operation of the WatchDog benchmark is to periodically test a shared register (i.e., WTCNT) value. When the register value is tested to be zero, the multitasking OS system determines that it is in a deadlock and will reset the system.

To demonstrate the accuracy of the DOM OS model, the WatchDog is implemented, which consists of two tasks. One task counts down the value of the shared register one by one and then checks the value at the end of each specified timeout period. The other task assigns a non-zero value to the register when it is triggered by a timer interrupt. The result is erroneous if the simulated value of the register is different from that of the CA OS model. The error rate is computed by dividing the number of erroneous results by the total number of register value checks.

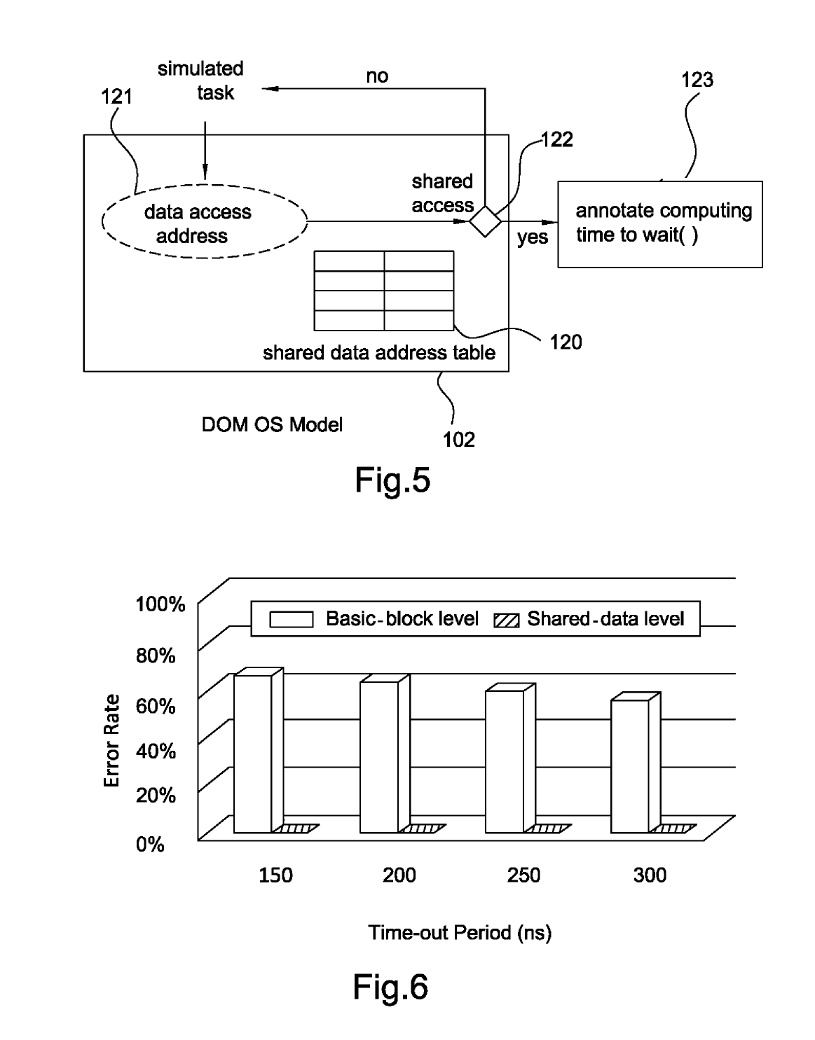

FIG. 6 shows the simulation accuracy of the WatchDog Timer with different OS modeling approaches. It is then varying the timeout period and controlling the frequency of timer interrupt to create different tests. As shown in FIG. 6, the proposed DOM OS model is always 100% accurate, matching the CA OS model, while the error rate of the BB OS model ranges from 56% to 66% as the time-out period becomes shorter.

The above descriptions are the preferred embodiments of the present invention. Those skilled in the art should appreciate that the scope of the present invention is not limited to the described preferred embodiments. The scope of the present invention is expressly not limited expect as specified in the accompanying claims. Various changes and modifications can be made within the spirit and scope of the present invention, as defined by the following Claims.

What is claimed is:

1. A data-dependency-oriented modeling method for efficient simulation of OS preemptive scheduling, comprising:
checking a data access address on a DOM OS model for each simulated software tasks;
computing a time to a next shared variable access by calling a wait function by said DOM OS model, followed by executing operation of said simulated software task and submitting a control back to a SystemC engine for simulating each hardware tasks; and
requesting said SystemC engine by a calling wait function by said DOM OS model to mimic a time delay for a preempted software task and trigger said preempted software task to execute when encountering a preemption event.

2. The method according to claim 1, further comprising a step of sending an interrupt to notify a processor when said hardware task needs to interact with a specific said simulated software task.

3. The method according to claim 2, wherein said processor suspends a current said simulated software task to invoke a corresponding interrupt service routine.

4. The method according to claim 3, further comprising a step of performing context switch by an OS scheduler to execute said specific simulated software task, otherwise executing said suspended simulated software task.

5. The method according to claim 1, further comprising a step of scheduling said simulated software tasks and said hardware tasks based-on said calling wait function by said SystemC engine.

6. The method according to claim 1, wherein said DOM OS model records an interrupt event in an Interrupt Event Queue when said interrupt event is issued by said hardware task.

7. The method according to claim 1, furthering comprising a step of checking an Interrupt Event Queue by said DOM OS model when said DOM OS model is invoked.

8. The method according to claim 7, further comprising a step of said preempted software task waiting a suspension time which is a computing time of said preempted software task execution, otherwise, an executing software task resuming execution at said next shared variable access after said checking said Interrupt Event Queue.

9. The method according to claim 8, wherein said checking of said preempted software task will be recursively executed until there is no interrupt in said Interrupt Event Queue.

10. The method according to claim 1, wherein said checking a data access address comprises checking whether said data access address is of a shared data access.

11. The method according to claim 10, if it is, said DOM OS model will compute a time from last shared variable access and annotate said computing time to said wait function to invoke said SystemC engine for simulation.

12. The method according to claim 10, if it is not, back to said simulated software task.
